(19) United States
(12) Patent Application Publication
(10) Pub. No.: US 2004/0169988 A1
(43) Pub. Date: Sep. 2, 2004

(54) Electromagnetic control device

(76) Inventor: Heinz Leiber, Oberriexingen (DE)

Correspondence Address: Robert W Becker & Associates, Suite B, 707 Highway 66 East, Tijeras, NM, 87059, US

(21) Appl. No.: 10/477,647

(22) PCT Filed: May 14, 2002
(86) PCT No.: PCT/EP02/05287

(30) Foreign Application Priority Data
May 14, 2001 (DE) 101234546
Jan. 29, 2002 (DE) 102032610
May 6, 2002 (DE) 102201994

(51) Int. Cl. H01H 47/00

(52) U.S. Cl. 361/160

(57) ABSTRACT

The invention relates to an electromagnetic control device for actuating a valve of an internal combustion engine. A locking system is provided in order to maintain the valve in at least one of its end positions and in at least one intermediate position.

The invention relates to an electromagnetic control device with the features of the preamble of Claim 1.

A control device of this kind is known from DE 197 12 062 A1.

It is known that in combustion engines at low speeds or low load, an improvement in combustion and hence a reduction in consumption can be achieved if the valves are not opened completely but operate in part strokes. Adjusting the control devices so that the associated valves are operated in part stroke means holding the valve at a relatively large air gap, which is only possible with relatively high electrical currents, whereby the consumption saving is reduced.

The invention is based on the object of structuring the control device so that this increased energy consumption does not occur.

This object is achieved by the features of Claim 1.

The holding system can act directly on the armature and hold this, but also act on the valve in particular its stem or a control element present between the armature and the valve, and hence hold the armature indirectly.

The holding system can be a catching system as known in principle from DE 197 12 062A1 or a clamping system as will be described in more detail below.

The invention can be applied to all control devices in which the armature performs a linear movement e.g. as known from DE 195 21 078 A1, and also in those in which the armature performs a swivel movement.

As will be shown below, the invention can be used particularly favourably in a twin arrangement of pairs of several valves. In the twin arrangement, the valves are arranged in line. The control devices with swivellable armatures which activate the valves are arranged alternately to the left and right of the valves. Here, the active part of the catching system, namely at least one electromagnet and possibly also a force directed opposite the force of this electromagnet e.g. a spring force or a permanent magnet system, can be utilised for the two valves of a twin. This arrangement can also be applied without part stroke formation.

The part stroke e.g. 1 mm can be achieved with the invention with very low power. Thus, the catching system can be designed such that in connection with the control of the main magnet, it works virtually wear-free.

Electromagnetic control devices are optimised for small holding force in the magnetic circuit. Therefore small air gaps and small magnetic losses are required. Thus, saturation of the magnetic circuit is avoided. The magnetic power required to “catch” the armature puts little load on the magnetic circuit as even with a relatively large air gap, the magnetic coil is switched from higher currents to lower (=magnetic flux), to prevent the magnet reaching its end position with too much excess force (=speed).

To start the system, a conventional system must be moved from the centre position to the end position by periodic stimulation of oscillations and/or high current intensities, which constitutes a high load on the on-board network. This is critical when starting the engine as here the load on the on-board network from the starter is already high. On use of the holding system according to the invention, the armature can be held in an end position or in the intermediate position so that it begins operation immediately on starting.

For example, to achieve different part strokes of e.g. 0.5 and 1 mm, two corresponding intermediate positions of the control device can be provided. With a corresponding design, the holding system works almost wear-free. The electrical energy consumption of the holding system is very low.

The invention is explained in more detail with reference to exemplary embodiments of the drawing.

These show:

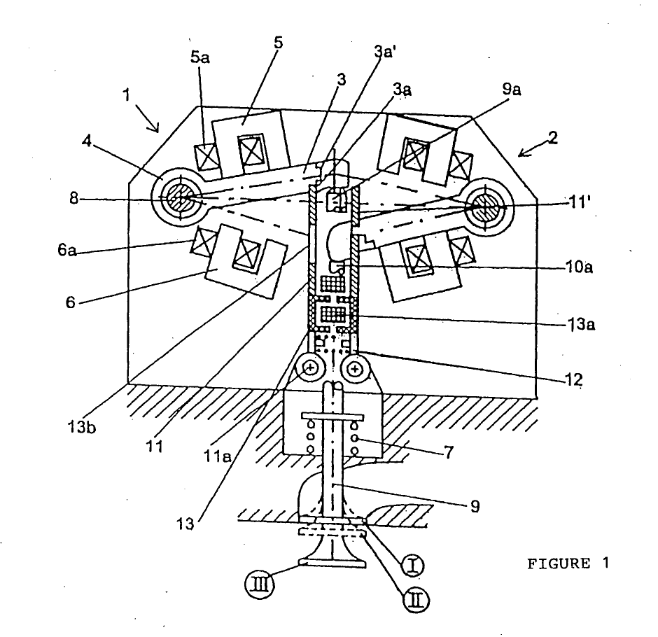

FIG. 1 an exemplary embodiment in which the armature is swivelled and the valve held by catching

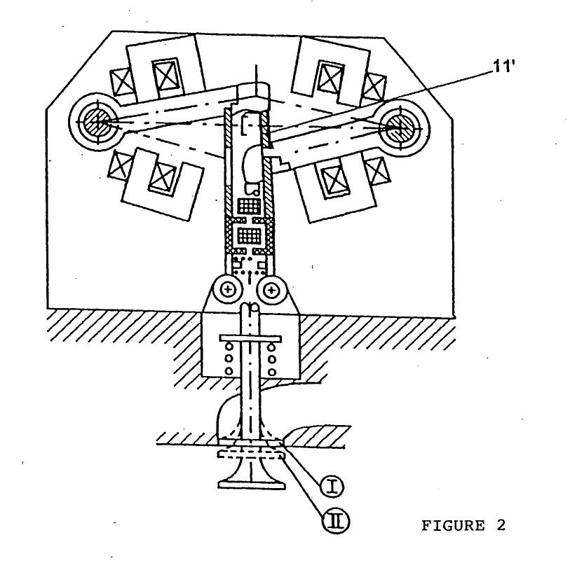

FIG. 2 the same exemplary embodiment with raised catching lever

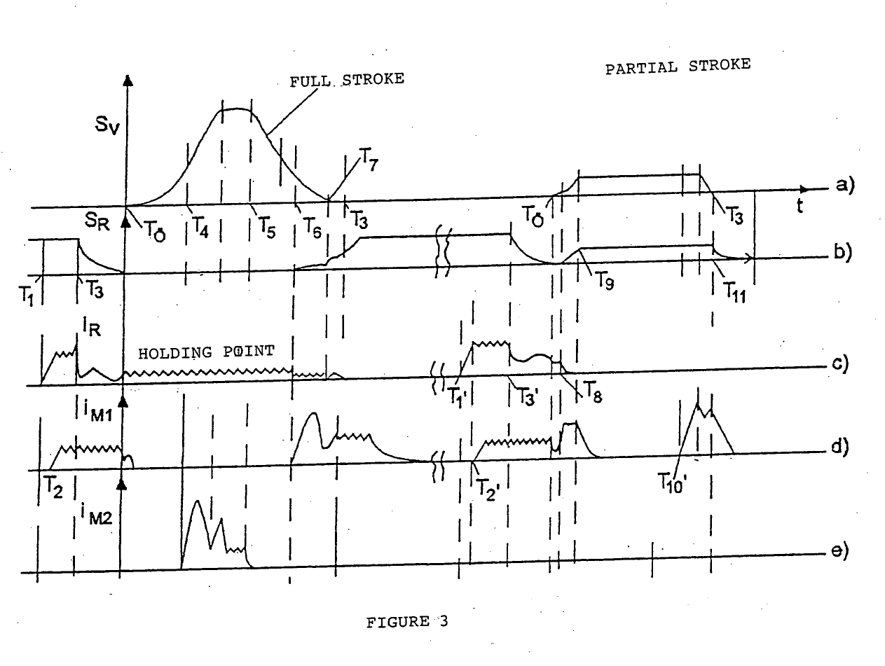

FIG. 3 a diagram in which the valve is shown over time in a part stroke setting

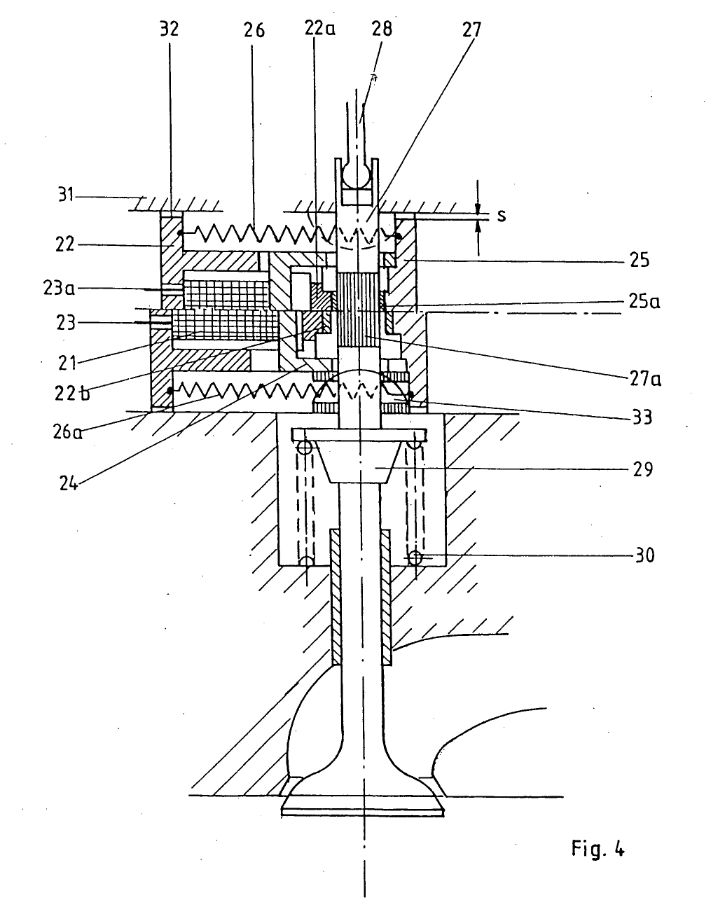

FIG. 4 an exemplary embodiment in which the valve is held by clamping.

FIG. 1 shows two control devices 1 and 2 which act on successively arranged valve stems 9a and 10a. They are arranged on different sides of the valves and offset against each other in the direction towards the plane of the paper.

The control device 1 and correspondingly also the control device 2 here have a lever 3 mounted swivellable at 4 in which is integrated the armature of the control device. In each control device are provided two electric magnets 5 and 6 each with a winding 5a and 6a. On the lever 3 act two opposing spring forces, namely a valve spring 7 and a torsion rod 8 acting on the bearing. Under the effect of these springs 7 and 8 and the electromagnets 5 and 6, the lever 3 is swivelled to and fro between the two end positions shown at the two control devices 1 and 2, and hence the valve 9 brought into the two end positions indicated with I and III, namely valve fully open (III) and valve closed (I).

In the end position I, the lever 3 and hence the valve 9 are held by a catching system. This is the case in the control device 1 shown on the left.

Each catching system has a catching lever 11 and 11′ mounted swivellable at 11a and pressed to the left or right by a spring 12. The lever 3 is formed slightly narrower at its free end and there has counter-catches 3a in which engages the end of the catching lever 11. In the drawing, the catching lever 11 is shown engaged in the lowest counter-catch which corresponds to the closed valve. Next to this is shown a second counter-catch 3a. When the catching lever 11 is engaged in this counter-catch, the lever 3 is held in an intermediate position and the valve 9 is in the part stroke position II.

In order to unlock the catching lever 11, a locking (electro)magnet 13 is provided. If its winding 13a is powered, the catching lever is drawn to the right out of engagement and the lever 3 is moved down by the force of the spring 8. Using the locking magnet 6 (shown on control device 2) the second end position III is reached in which the valve is held open.

Here, the lug 3a′ formed on the lever 3 engages in an opening 11b on the catching lever 11 and holds the lever in this second end position (as shown for the control device 2) without further power to the catching magnet. One condition naturally is that the power to the locking magnet has previously been terminated so that the lug 3a′ of the lever 3 lies at the free end of the catching lever 11 and can finally engage.

In FIG. 2 which otherwise corresponds to FIG. 1, the disengaged state of catching lever 11′ is shown. By corresponding power to the locking magnet, this unlocked position of the catching lever can be retained until the desired locking position is approximately reached and thus the grinding of the lug 3a′ on catching lever 11 is largely avoided, which leads largely to absence of wear.

For reasons of wear and due to the restricted magnetic force of the locking magnet, in order to release the catching lever it is necessary to supply power briefly to the corresponding electromagnets 5 or 6, e.g. in order to unlock the catching lever 11 from the position shown on the left in FIG. 1, to the electromagnet 5.

The drawing shows the feature that the locking magnet 13 and the spring 12 for the catching levers 11 and 11′ are responsible for both control devices 1 and 2 shown which form the so-called twin. The two control devices can work in parallel or separately. If e.g. only one valve is working, the locking magnet is connected as described. On the valve which is not working, i.e. which must remain closed, the closing magnet 5 or the corresponding magnet of the control device 2 is not powered.

Thus, the contact force of the spring 8 transferred to the lever 11 by the armature lever 3 is so great that the magnetic force of the locking magnet 13 is not sufficient to trigger the release i.e. movement of lever 1.

Using the diagram in FIG. 3, the procedure is described of the armature movement, once into the two end positions I and III and once from position I to part stroke position II and back. FIG. 3a shows the stroke of the armature or valve Sᵥ, FIG. 3b the stroke of the catching lever S_{R}, FIG. 3c the current development i_{R} of the locking magnet, FIG. 3d the current i_{M1} in the closing magnet 5 and FIG. 3e the current i_{M2} of the opening magnet 6 over time.

Until T₀ the valve is held “closed” in position I and in this position is held by the catching lever 11. To release the valve 9, at T₁ the catching current i_{R} is switched on and a little later at T₂ the magnet 5 is also powered. This facilitates the release and ensures that this takes place with low wear. After T₃ the catching lever 11 moves and unlocks at T₀. Due to the force of torsion spring 8, the valve is accelerated. At T₄ the current of the opening magnet 6 is switched on, using which the valve is brought to the other end position III.

The outlined procedure with full stroke is typical for high rotation speeds with short opening times, so catching has little effect in saving electrical power.

The current of the closing magnet is then reduced to the value sufficient to hold. At T₅ the holding current i_{M2} is switched off and the valve 9 is now accelerated by the valve spring 7 in the opposite direction. At T₆ the catching current iₘ₁ of magnet 5 is switched on, which brings the valve to the other end position I and holds it with a holding current until the catching lever 11 is engaged.

During the movement of the valve from position I to open position III and during the pause there of the valve 9, and also for part of the return movement up to time T₆, the locking magnet 13 is exposed to a low cyclic current marked in the drawing which lifts the end of the catching lever 11 from the lever 3 and prevents grinding of the parts on each other. At T₆ the current of the locking magnet is reduced such that the catching lever 11 now lies on the armature 3. At T₇ engagement begins. The movement of the catching lever on engagement has a feedback effect on the current i_{R} (at T₇). As the catching position is a fixed position, this current change (namely because of the mutual inductance initiated by the armature movement) can serve at least as an auxiliary signal for the position determination, e.g. to calibrate a position sensor.

After a longer closing time of valve 9 in which no magnet is consuming current, at T₁′ or T₂′ release is initiated. In contrast to the process described above, on initiation of the part stroke of the current of magnet 5 is switched off only briefly to allow the valve movement. The current of the magnet is regulated here so that the armature lever moves slightly beyond catching position II. At time T₈ the catching current i_{R} is switched off so that the catching lever 11 can reach the counter-catch 3a and hold the valve in the part stroke position II. The current i_{M1} of magnet 5 is then regulated so that lever 3 at T₉ settles with a low contact speed on the catching lever 11.

Shortly before the valve closing time Tₛ at T₁₀ the closing magnet is reconnected which leads to a movement of the armature lever 3 and the valve 9 until valve closure and then until contact of the armature lever 3 on the yoke 5. This movement is also regulated so that low contact speeds apply for the valve 9 and the armature lever 3. In this process, no current is required in the locking magnet. Due to the spring force, the catching lever moves into the catching position I. Then at (11), in the closing magnet a regulated current reduction occurs to achieve a soft settling of the armature lever on the catching lever.

This part stroke procedure is advantageous at low rotation speeds or low load and is used in these situations.

FIG. 4 shows an exemplary embodiment in which the valve stem is held by clamping instead of catching, which is possible in any position of the valve.

The drawing shows the construction of the clamping element. A piezoactuator 21 is embedded in the housing 22 which has recesses for connections 23 and 23a. The force of the piezoactuator acts on this housing 22 and a transfer part 24 which rests on a clamping part 25. This is recessed accordingly in the clamping zone and in the clamping region 25a consists of hard material e.g. hard metal. The upper half of the picture shows the clamping and the lower half the free running. On the side opposite part 25 the second clamping region is shown as a continuation 22a of the housing 22. Here too, the clamping zone 22b has hard material. The clamping force is generated via two opposing springs 26 and 26a which act on the housing 22 and the transfer part 24. The extended stem 27 of a valve is clamped here. This too is designed hard in the clamping zone 27a. A control element 28 of an electromagnetic actuator which is not shown acts on the valve stem. The valve is coupled via a spring plate 29 with a valve spring 30.

In rest state i.e. without triggering the piezoactuator 21, the clamp parts 22, 22a and 22b or 24, 25, 25a respectively, because of the effect of springs 26 and 26a, are in the clamping position shown above. If the clamping is now released, the piezoactuator 21 is placed under voltage and it exercises its physical effect accordingly. The expansion acts on the housing 22 as an action force and at the same time via the transfer part 24 on the clamp part 25 and 25a as a reaction force. Thus, the clamp element is spread and an air gap appears between the valve stem 27 and the clamping zones 22a and 25a. The spring 30 and the second spring force not shown of the electromagnetic valve drive then, depending on the position of the valve, move this in one of the two directions. The clamping is thus direction-independent. This state is shown at the bottom in the drawing.

The clamping element must be supported on both sides. For this, the electromagnetic actuator can be used. The support 31 is shown above hatched in principle. As the clamping element must absorb tolerances, floating mounting is advantageous with a small play S. So that only a slight friction occurs in tolerance adaptation, the housing 22 and the clamping part 25 are fitted with slip elements 32. On clamping of a valve stem, angle tolerance can also occur. To avoid these, a dome-shaped bearing 33 on the clamping part 25 can be used axial to the valve axis. This is shown sketched below and in dotted lines above.

### FIG. 3

Vollhub=full stroke

Teilhub=part stroke

Haltepunkt=holding point

1. Electromagnetic control device (1) to drive a valve (9) of a combustion engine with at least one electromagnet (5, 6) and one moveably mounted armature which without triggering the at least one electromagnet (5, 6) is held in an intermediate position by two opposingly directed spring forces (4, 7) and which by the interaction of the at least one electromagnet (5, 6) and the spring forces (4, 7) is moved to and fro between the poles of the at least one electromagnet (5, 6), where the armature movement is transmitted to the valve (9) and after reaching the end positions lying at least in the vicinity of the pole surfaces is held at times directly or indirectly, where this holding takes place at least in the end position (I) belonging to the closed valve by a holding system (11 to 13), characterised in that at least one intermediate position (II) is provided preferably in the vicinity of the end position allocated to the closed valve (position I) and that the same holding system (11 to 13) holds the armature also in this at least one intermediate position (II).

2. Electromagnetic control device according to claim 1, characterised in that the holding system is a catching system (11 to 13).

3. Electromagnetic control device according to claim 2, characterised in that in order to catch, for each armature a catching lever (11) is provided which can be moved by the force of an electromagnet (locking magnet 13) against a second force (12) acting on this and which can engage in counter-catches (3a, 3a′) provided on the armature or a part (3) connected thereto.

4. Electromagnetic control device according to claim 3, characterised in that the second force is a spring (12).

5. Electromagnetic control device according to claim 3, characterised in that the second force is formed by permanent magnets.

6. Electromagnetic control device according to any of claims 3 to 5, characterised in that the catching lever (11) and the second force (12) acting on this are constructed such that the catching lever (11) lies on the armature or a part (3) connected thereto and that the catching lever can be lifted from the armature or part (3) by the force of the locking magnet (13).

7. Electromagnetic control device according to claim 6, characterised in that during the armature movement the catching lever (11) is lifted at least into the vicinity of the desired engagement position of the armature or part (3).

8. Electromagnetic control device according to any of claims 2 to 7, characterised in that for release the at least one electromagnet (5) is also triggered.

9. Electromagnetic control device according to any of claims 2 to 8, characterised in that the power to at least one electromagnet (5, 6) is controlled such that the counter-catches (3a, 3a′) settle with low speed on the catching lever.

10. Electromagnetic control device according to any of claims 2 to 9, characterised in that the catching movement is at least partly also utilised to detect the position of the armature.

11. Electromagnetic control device, in particular according to any of claims 2 to 10, characterised in that on arrangement of the valves (9) in line, alternately left and right of this are arranged electromagnetic control devices (1 and 2) which activate the valves (9) by a swivel movement, one locking magnet (13). being allocated to two adjacent control devices (1 and 2).

12. Electromagnetic control device according to claim 1, characterised in that the holding system is a clamping system (21 to 26).

13. Electromagnetic control device according to claim 12, characterised in that the clamping system contains clamping means (22, 22a, 22b; 24, 25, 25a) and an electrically controllable actuator (2) which operates the clamping means and when triggered undergoes a length change which is transmitted to the clamping means, where the clamping means comprise two moveably mounted clamping parts (22, 22a, 22b; 24, 25, 25a) acting from opposing directions on the part (7), on which clamping parts act the spring forces (26, 26a) directed towards the part (27), and that the length change of the actuator (21) is transmitted to the two clamping parts (22, 22a, 22b; 24, 25, 25a) in the sense of moving the clamping parts away from each other.

14. Electromagnetic control device according to claim 13, characterised in that the actuator is a piezoactuator (21).

15. Electromagnetic control device according to claim 13 or 14, characterised in that the clamping means, at least at the zones (22a, 25a) acting directly on the clamp, are made of hard material.

16. Electromagnetic control device according to claim 13 to 15, characterised in that at least the zones (27a) of the part (27) on which the clamp acts, are made of hard material.

17. Electromagnetic control device according to any of claims 13 to 16, characterised in that the clamping parts (22, 22a, 22b; 24, 25, 26) are mounted floating.

18. Electromagnetic control device according to any of claims 13 to 17, characterised in that the clamping parts (22, 22a, 22b; 24, 25, 26) are mounted at least partly in domes (33).

19. Electromagnetic control device according to any of claims 12 to 18, characterised in that slip elements (32) are provided for mounting the clamping parts (22, 22a, 22b; 24, 25, 26).

20. Electromagnetic control device according to any of claims 1 to 19, characterised in that the fixing system (11 to 13) acts on the valve or on a control part arranged between the armature and the valve (9).
